(19) United States
(12) Patent Application Publication
(10) Pub. No.: US 2016/0247597 A1
(43) Pub. Date: Aug. 25, 2016

(54) WIRE COVERING MATERIAL AND COVERED WIRE

(71) Applicant: MITSUBISHI RAYON CO., LTD., Chiyoda-ku, Tokyo (JP)

(72) Inventors: Atsushi KUWAHARA, Otake-shi (JP); Hiroyuki NISHII, Otake-shi (JP); Shinya HIRAI, Otake-shi (JP)

(73) Assignee: Mitsubishi Rayon Co., Ltd., Chiyoda-ku, Tokyo (JP)

(21) Appl. No.: 15/024,412

(22) PCT Filed: Sep. 12, 2014
(86) PCT No.: PCT/JP2014/074317

§ 371 Date: Mar. 24, 2016

(30) Foreign Application Priority Data
Sep. 25, 2013 (JP) 2013-198486

(51) Int. Cl. H01B 3/44; C09D 127/06

(52) U.S. Cl. CPC H01B 3/44; C09D 127/06

(57) ABSTRACT

A wire covering material and a covered wire using the wire covering material is provided, wherein the wire covering material is formed by molding a vinyl chloride based resin composition which includes 0.1 parts by mass to 20 parts by mass of (B) and 10 parts by mass to 150 parts by mass of (C) based on 100 parts by mass of (A), and which is excellent in surface smoothness even when manufactured under high linear speed production condition.
(A) A vinyl chloride based resin;
(B) A powdery processing aid including an alkyl methacrylate based copolymer which is obtained by polymerizing a 10 mass % to 100 mass % of an alkyl methacrylate for which the alkyl group of the alkyl ester part includes a straight chain or branched alkyl group having 3 to 5 carbons, 0 mass % to 90 mass % of a methyl methacrylate, and 0 to 20 mass % of other copolymerizable monomer.
(C) A plasticizer.

### BACKGROUND OF THE INVENTION

1. Field of the Invention

The present invention generally relates to a wire covering material, in particular, to a wire covering material having excellent surface smoothness even when manufactured under high linear speed production conditions.

2. Description of Related Art

Vinyl chloride based resin has excellent chemical/physical properties, such as chemical resistance, weather resistance, flame retardance and electrically insulating properties. It is also inexpensive and therefore has been widely used as a high-valued universal resin material. Due to the excellent properties of flexible vinyl chloride based composition, or by adding a plasticizer to easily impart flexibility, flexible vinyl chloride based resin has been widely applied. In particular, its use for wire covering has become one of the main purposes of vinyl chloride based resins.

On the other hand, although vinyl chloride based resin is relatively inexpensive, its production cost also have strict requirements. In order to further increase the productivity, its production with a high production speed (high linear speed production conditions) is under evaluation.

However, during mold processing under high linear speed production conditions, the retention and kneading time of the resin inside the molding machine is very short. Therefore, the melting and kneading process tends to be insufficient. In addition, since the mold processing of the vinyl chloride based resin is only performed under narrow conditions, a satisfactory molded product cannot be readily obtained by changing only the mold processing conditions.

In particular, as compared to other mold processing, the molding of a covered wire has a relatively fast production speed. For instance, thin wires having a diameter of a few millimeters (mm) are extruded at 1000 m/min or more for coating, and thick wires of around 50 mm φ are extruded at 15 m/min˜30 m/min for coating. In this case, the shearing rate goes up to 7000/s. Such high shear rate production conditions are unique for coated wires, and in combination with the insufficient kneading caused by a short retention kneading time, the increase of the production speed is limited in the conventional art due to the poor appearance under such conditions. Regarding this issue, in order to meet the demands for increasing the production speed, a new method to improve the state of kneading is expected.

In general, to improve the kneading state of the vinyl chloride based resin, various methods have been proposed for instance, by adding acrylic based resin with high molecular weight to promote melting and impart melt viscosity.

For example, as disclosed in patent literature 1 to patent literature 3: in a vinyl chloride resin covered wire, acrylic based resin for which methyl methacrylate is the main component was used as a processing aid for improving its processing and dispersion properties.

Furthermore, as disclosed in patent literature 4: by using acrylic based resin as a modifier in the vinyl chloride based resin, a molded product suitable for metal covering and having excellent shape conformability can be obtained.

However, under high linear production conditions, a molded product with satisfactory surface smoothness still cannot be obtained. Hence, the current techniques are insufficient.

Based on the above, a wire covering material having excellent surface smoothness even when manufactured under high linear speed production conditions is desired.

### PATENT DOCUMENTS

[Patent Document 1] Japanese Laid Open Publication No. H2-218732

[Patent Document 2] Japanese Laid Open Publication No. 2001-234014

[Patent Document 3] Japanese Laid Open Publication No. 2002-179868

[Patent Document 4] Japanese Laid Open Publication No. H8-188691

### SUMMARY OF THE INVENTION

### Problems to be Solved

Accordingly, the object of the present invention is to provide a wire covering material having excellent surface smoothness even when manufactured under high linear speed production conditions and a covered wire using the same.

### Means of Solving the Problem

As discovered, the problems mentioned in the present invention can be solved by using the wire covering material described below. The wire covering material is formed by molding a vinyl chloride based resin composition, which includes adding a specific amount of a powdery processing aid including a specific alkyl methacrylate based copolymer and a plasticizer to a vinyl chloride based resin.

That is, the present invention is related to [1]˜[1] as listed below.

[1]A wire covering material, wherein the wire covering material is formed by molding a vinyl chloride based resin composition which includes 0.1 parts by mass to 20 parts by mass of (B) and 10 parts by mass to 150 parts by mass of (C) based on 100 parts by mass of (A):
(A) a vinyl chloride based resin;
(B) a powdery processing aid including an alkyl methacrylate based copolymer which is obtained by polymerizing 10 mass % to 100 mass % of an alkyl methacrylate for which an alkyl group of an alkyl ester part includes a straight chain or branched alkyl group having 3 to 5 carbons, 0 mass % to 90 mass % of a methyl methacrylate, and 0 mass % to 20 mass % of other copolymerizable monomer;
(C) a plasticizer.

[2] The wire covering material according to [1], wherein the straight chain or branched alkyl group having 3 to 5 carbons is a straight chain or branched alkyl group having 4 carbons.

[3] The wire covering material according to [1] or [2], wherein the straight chain or branched alkyl group having 3 to 5 carbons is a straight chain alkyl group.

[4] The wire covering material according to any one of [1] to [3], wherein the alkyl methacrylate for which the alkyl ester part includes the straight chain or branched alkyl group having 3 to 5 carbons used in the processing aid (B) is n-butyl methacrylate.

[5] The wire covering material according to any one of [1] to [4], wherein the vinyl chloride based resin composition further comprises 1 to 150 parts by mass of a filler (D).

[6] The wire covering material according to [5], wherein the filler (D) is at least one selected from the group consisting of calcium carbonate, talc, titanium oxide, clay, mica, silica limestone, zeolite, silica, carbon black, graphite, glass beads, glass fibers, carbon fibers, metal fibers and organic fibers.

[7] The wire covering material according to any one of [1] to [6] wherein the vinyl chloride based resin composition further comprises 1 to 150 parts by mass of a flame retardant (E).

[8] The wire covering material according to [7], wherein the flame retardant (E) is at least one selected from the group consisting of metal hydroxides, bromine based compounds, triazine ring containing compounds, zinc compounds, phosphorus based compounds, halogen based flame retardants, silicone based flame retardants, intumescent based flame retardant and antimony oxide.

[9] The wire covering material according to any one of [1] to [8], wherein the plasticizer (C) is at least one selected from the group consisting of o-phthalic acid based compounds, trimellitic acid based compounds, phosphoric acid based compounds, adipic acid based compounds, citric acid based compounds, ether based compounds, polyester based compounds and soybean oil based compounds.

[10] The wire covering material according to any one of [1] to [9], wherein the vinyl chloride based resin (A) is at least one selected from a vinyl chloride polymer having an average chlorine content of 56 to 75 mass % and a vinyl chloride based copolymer formed by copolymerizing the vinyl chloride polymer with an elastomeric body and/or elastomer.

[11]A wire, covered by the wire covering material according to any one of [1] to [10].

### Effects of the Invention

The wire covering material of the present invention has excellent surface smoothness even when manufactured under high linear speed production conditions, hence having a clear advantage when used in the industry.

### BRIEF DESCRIPTION OF THE DRAWINGS

None

### DESCRIPTION OF THE EMBODIMENTS

Reference will now be made in detail to the present invention.

<Vinyl Chloride Based Resin (A)>

The type of vinyl chloride based resin used in the vinyl chloride based resin (A) of the present invention is not particularly limited. Examples may include: vinyl chloride homopolymer, post-chlorinated vinyl chloride polymers, partially cross-linked vinyl chloride polymers, or copolymers formed by copolymerizing 30% mass or less of other vinyl based compounds that are co-polymerizable with vinyl chloride with vinyl chloride, and a mixture thereof.

The other vinyl based compounds that are co-polymerizable with vinyl chloride is not particularly limited. Specific examples include: vinyl acetate, vinyl propionate and other fatty acid vinyl esters; methyl methacrylate, ethyl methacrylate and other alkyl methacrylates; ethyl acrylate, butyl acrylate and other alkyl acrylates; ethylene, propylene, styrene and other α-olefins; vinyl methyl ether, vinyl butyl ether and other alkyl vinyl ethers; acrylic acid, methacrylic acid, maleic anhydride and other unsaturated carboxylic acids or anhydrides. The compounds can be used alone or in a combination of two or more. In the case where the other vinyl based compounds that are co-polymerizable has a copolymerization amount of less than 30 mass %, then the original properties of the vinyl chloride based resin will not be affected, hence is more preferred.

The vinyl chloride based resin is preferably a resin selected from at least one of a vinyl chloride polymer having an average chlorine content of 56 mass % to 75 mass %, and a vinyl chloride based copolymers formed by copolymerizing the vinyl chloride polymer with an elastomeric body and/or elastomer. Furthermore, the vinyl chloride based resin can be used alone, or in a combination of two or more.

Additionally, the vinyl chloride based resin (A) used in the present invention preferably has an average degree of polymerization in a range of 300˜5000, and more preferably 500˜3000. By setting the average degree of polymerization to 300 or more, the mechanical properties of the wire covering material becomes better. Furthermore, by setting the average degree of polymerization to 5000 or less, the processing properties become better.

The manufacturing method of the vinyl chloride based resin (A) used in the present invention is not particular limited, and can be a vinyl chloride based resin manufactured by emulsion polymerization, suspension polymerization, bulk polymerization and other various polymerization methods.

<Processing Aid (B)>

The processing aid (B) used in the present invention is a powdery processing aid. It contains an alkyl methacrylate based copolymer (hereinafter polymer (β)), which is obtained by polymerizing 10 mass % to 100 mass % of an alkyl methacrylate (b-1) for which the alkyl group of the alkyl ester part includes a straight chain or branched alkyl group having 3 to 5 carbons (hereinafter monomer (b-1)), 0 mass % to 90 mass % of methyl methacrylate (b-2) (hereinafter monomer (b-2)), and 0 mass % to 20 mass % of other co-polymerizable monomers (b-3) (hereinafter monomer (b-3)).

Regarding all the monomer (b-1) used in the present invention, the alkyl group of the alkyl ester part includes a straight chain or branched alkyl group having 3 to 5 carbons. In the case where the alkyl group has 3 carbons or more, the bulkiness of the molecular chain becomes sufficient. As such, the dispersibility of the processing aid (B) becomes better, and the melt (gelling) of the vinyl chloride based resin during molding can be promoted, and the appearance of the wire covering material can be improved. Furthermore, when the alkyl group has 5 carbons or less, the lowering of the glass transition temperature of the processing aid (B) can be inhibited, and the recovery of the powder can be improved. In particularly, it is preferred that the alkyl group has 4 carbons. By setting the alkyl group to 4 carbons, the balance between the dispersibility and the powder recoverability of the processing aid (B) becomes better.

The alkyl group of the alkyl ester part is preferably a straight chain alkyl group. By choosing the alky group of the alkyl ester part being a strain chain, the molecular chain can efficiently impart bulkiness without causing a substantial decrease in polarity. As such, it can have a good compatibility with the vinyl chloride based resin, and an interaction between the molecular chains of the polymer (β) can be weakened, and the dispersibility of the processing aid (B) during molding can be increased. As such, gelation is promoted and the kneading uniformity is increased, hence an appearance of the wire coating material is also improved.

Examples of monomer (b-1) includes: n-propyl methacrylate, n-butyl methacrylate, n-amyl methacrylate, isopropyl methacrylate, isobutyl methacrylate, isoamyl methacrylate, tert-butyl methacrylate, tert-amyl methacrylate, sec-butyl methacrylate, neopentyl methacrylate etc. Preferably, it is n-butyl methacrylate which has a good balance between the ability to improve the appearance of the wire coating material and for powder recoverability.

Depending on the purpose, the alkyl methacrylate can be used alone or in combinations of two or more of the above compounds.

Methyl methacrylate is used as a monomer (b-2). By using methyl methacrylate, a high gloss to the wire coating material can be imparted.

Other co-polymerizable monomers (b-3) can also be used.

Monomer (b-3) is not particularly limited as long as it is a monomer that can co-polymerize with monomer (b-1). Examples may include: ethyl acrylate, butyl acrylate, 2-ethylhexyl acrylate, benzyl acrylate, phenyl acrylate and other acrylates; ethyl methacrylate, hexyl methacrylate, octyl methacrylate, 2-ethylhexyl methacrylate and other alkyl methacrylates wherein the alkyl group has 2 carbons or 6 carbons or more; benzyl methacrylate, phenyl methacrylate and other aromatic ester methacrylates; styrene, α-methyl styrene, vinyl toluene and other aromatic vinyl compounds; acrylonitrile, methacrylonitrile, and other vinyl cyanide compounds; vinyl acetate and other vinyl esters; maleic anhydride and other anhydrides. The above monomers can be used alone or in a combination of two or more.

Based on all the monomers that become the starting material of polymer (3) being a total of 100 mass %, the usage amount of monomer (b-1) is 10 mass %˜100 mass %, preferably 20 mass %˜90 mass %, more preferably 25 mass %˜80 mass %, and most preferably 40 mass %˜80 mass %. By setting the usage amount of monomer (b-1) to more than 10 mass %, the gelation properties becomes sufficient and a wire covering material with an improved appearance effect can be obtained.

Based on all the monomers of the polymer (β) having a total of 100 mass %, the usage amount of monomer (b-2) is 0 mass %˜90 mass %, preferably 10 mass %˜80 mass %, more preferable 20 mass %˜75 mass %, and most preferably 20 mass %˜60 mass %. By setting the usage amount of monomer (b-2) to less than 90 mass %, the melting and kneading process of the vinyl chloride based resin can be efficiently performed, and a wire covering material with an improved appearance effect (surface smoothness) can be obtained.

Based on all the monomers of the polymer (β) having a total of 100 mass %, the usage amount of monomer (b-3) is 0 mass %˜20 mass %, preferably 0 mass %˜10 mass %.

By setting the usage amount of the monomer (b-3) to less than 20 mass %, the melting and kneading process of the vinyl chloride based resin can be efficiently performed, and the objective of the present invention by having a wire covering material with good appearance can be accomplished without interference.

Furthermore, other polyfunctional monomers such as divinyl benzene, allyl methacrylate, 1,3-butanediol dimethacrylate, and triallyl cyanurate can be used as monomer (b-3). Based on all the monomers of the polymer (3) having a total of 100 mass %, the usage amount of the polyfunctional monomers is preferably 0.1 mass %˜2 mass %, and more preferably, 0.2 mass %˜1 mass %. In the case where the usage amount of the polyfunctional monomer is less than 2 mass %, then the objective of using the processing aid (B) for providing a good appearance to the wire covering material can be accomplished without interference, hence it is more preferable.

A variety of methods can be used for the production of polymer (β), for example, polymerization methods include emulsion polymerization, suspension polymerization, and solution polymerization. Furthermore, the monomers can be added all at once, drop-wise, or the monomers may be added in portion, or added using any other methods. In addition, methods such as random copolymerization or block copolymerization can be used. However, it is more preferred to obtain a random copolymer by a one time addition of the monomers.

In the case of emulsion polymerization, the emulsifiers used are not particularly limited and various emulsifiers can be used. Examples may include: fatty acid salts, alky sulfate ester salt, alkyl benzene sulfonate, alkyl phosphate ester salt, dialkyl sulfosuccinates and other anionic surfactants; polyoxyethylene alkyl ether, polyoxyethylene fatty acid ester, sorbitan fatty acid esters, glycerin fatty acid esters and other nonionic surfactants; alkylamine salts and other cationic surfactants. In addition, these emulsifiers can be used alone or used in combination.

Furthermore, when the polymerization system has an alkaline pH value due to the type of emulsifiers used, suitable pH adjusting agents can be added to prevent the hydrolysis of the alkyl methacrylate. The pH adjusting agents that may be used are such as: boric acid-potassium chloride-potassium hydroxide, potassium dihydrogen phosphate-disodium hydrogen phosphate, boric acid-potassium chloride-potassium carbonate, citric acid-potassium citrate, potassium dihydrogen phosphate-borax, disodium hydrogen phosphate-citric acid etc.

In addition, the polymerization initiator can be water soluble, oil soluble and may be a single system or a redox system. For example, general inorganic initiators such as persulfate may be used alone, or may be used in combination with sulfite, bisulfite, thiosulfate and become a redox system initiator. Furthermore, organic peroxides such as tert-butyl hydroperoxide, cumene hydroperoxide, benzoyl peroxide or lauroyl peroxide, or azo compounds may be used alone, or may be used in combination with sodium formaldehyde sulfoxylate to become a redox system initiator. However, the present invention is not limited to the above specific examples.

The method of powder recovery for the polymer (β) is not particularly limited. For example, in the case of using the emulsion polymerization method, the obtained alkyl methacrylate based polymer emulsion maybe cooled down, then acids such as sulfuric acid, hydrochloric acid and phosphoric acid, or salts and electrolytes such as aluminum chloride, calcium chloride, magnesium sulfate, aluminum sulfate, calcium acetate may be used for acid coagulation or salting so as to precipitate the polymer. The precipitate is then filtered, washed and dried to obtain the powder. In the present invention, good powder recoverability tends to mean that under general powdering conditions, the polymer (β) will not become a coarse powder or over fine powder, hence, the powder is easy to be recovered.

Furthermore, methods such as spray drying or freeze drying may be used for the recovery. In order to obtain a wire covering material with a good molding appearance, spray drying is more preferred.

Spray drying refers to process where the spray drying apparatus sprays out the polymer emulsion in fine droplets and subsequently is blown with hot air to perform drying.

In the spray drying apparatus, the method of spraying the polymer emulsion in fine droplets may be for example: using rotating disc type, pressure nozzle type, two fluid nozzle type, pressurized two fluid nozzle type methods etc.

The capacity of the spray drying apparatus may be any one of a small-scale capacity used in the laboratory to a large scale capacity as used in the industry.

The structure of the supplying unit of the heating gas used for drying in the spray drying apparatus, and the discharging unit of the heating gas and the dried powder may be appropriately selected depending on different purposes.

The heating gas used for drying may preferably have a temperature of less than 200° C., and more preferably 120° C.˜180° C.

Regarding the molecular weight of the polymer (β), it is not particularly limited, but preferably it has a reduced viscosity ηsp/c set to 0.5˜15, and more preferably set to 2˜15, even more preferably set to 4˜14, and most preferably set to 4˜9. By setting the ηsp/c to above 0.5, the gelling promoting ability and the ability to increase the kneading degree may be further improved. By setting the ηsp/c to below 15, the burden on the molding machine may be reduced, and additionally, the dispersibility of the processing aid (B) becomes better.

Moreover, the reduced viscosity ηsp/c of the present invention tends to mean a value measured at 25° C. by dissolving 0.1 g of (co)polymer into 100 mL of chloroform. The method of adjusting the reduced viscosity ηsp/c may include: general methods such as adjusting the chain transfer agent during polymerization, adjusting the amount of the initiator and adjusting the polymerization temperature etc.

Chain transfer agents may for example include: n-octyl mercaptan, tert-dodecyl mercaptan and other alkyl mercaptan.

The usage of the chain transfer agent is not particularly, but based on all the monomer in the polymer (β) being 100 parts by mass, it is preferably 0 parts by mass˜2 parts by mass, more preferably 0 parts by mass˜1 parts by mass, and even more preferably 0 parts by mass˜0.5 parts by mass.

In addition, in the processing aid (B) of the present invention, besides having the polymer (β), it may also contain additives when necessary. Additives may for example include inorganic salts, fumed silica (Aerosil) and other powder flow modifiers.

<Plasticizer (C)>

The plasticizer (C) refers to an additive when added to the vinyl chloride based resin, it is used to interfere with the fixed interaction between the molecular chains of the vinyl chloride based polymer, and to expand the distance between the molecular chains of the vinyl chloride based polymer. As such, flexibility can be imparted to the vinyl chloride based resin.

The plasticizer (C) used in the present invention is not particularly limited, and preferably, selected from at least one of phthalic acid based compounds, trimellitic acid based compounds, phosphoric acid based compounds, adipic acid based compounds, citric acid based compounds, ether based compounds, polyester based compounds and soybean oil based compounds. Examples may include: dioctyl phthalate, diisononyl phthalate, diisodecyl phthalate and other dialkyl phthalates; butyl benzyl phthalate and other alkyl benzyl phthalates, alkyl aryl phthalates, dibenzyl phthalate, diaryl phthalate; tris(2-ethylhexyl) trimellitate, and other trialkyl trimellitates; tricresyl phosphate and other triaryl phosphate, trialkyl phosphates; alkyl aryl phosphates; adipate, acetyl tributyl citrate and other citrates; polypropylene glycol and other ether compounds; polyester based compounds; epoxidized soybean oil and other soybean oil based compounds.

The above compounds may be used alone or it may be used in a combination of two or more.

Based on 100 parts by mass of the vinyl chloride based resin (A), the processing aid (B) in the vinyl chloride based resin molded to the wire covering material is in an amount of 0.1 parts by mass˜20 parts by mass, preferably 0.5 parts by mass˜15 parts by mass, more preferably 2 parts by mass˜10 parts by mass. By setting the addition amount of the processing aid (B) to more than 0.1 parts by mass, the gelation properties becomes better, and a wire covering material with an improved appearance effect can be achieved. Furthermore, by setting it to less than 20 parts by mass, a significant increase of the melt viscosity within the molding machine can be prevented, the wire covering material can have a good appearance, and the overloading of the motor by the molding machine may be prevented.

Based on 100 parts by mass of the vinyl chloride based resin (A), the plasticizer (C) is in an amount of 10 parts by mass˜150 parts by mass, preferably 30 parts by mass˜150 parts by mass, more preferably 30 parts by mass˜100 parts by mass and most preferably 30 parts by mass˜60 parts by mass. By setting the addition amount of the plasticizer to more than 10 parts by mass, the flexibility becomes sufficient. Additionally, by setting it to less than 150 parts by mass, the lowering of the mechanical properties, the flame retardancy and electrical properties may be prevented.

<Filler (D)>

In the vinyl chloride based resin composition that is molded into a wire covering material, it may further contain a filler (D).

Filler (D) is not particularly limited, and preferably may be selected from at least one of calcium carbonate, talc, titanium oxide, clay, mica, silica limestone, zeolite, silica, carbon black, graphite, glass beads, glass fibers, carbon fibers, metal fibers and organic fibers. In the filler, the above compounds may be used alone or in a combination of two or more.

Regarding the addition amount of the filler (D), it is not particularly limited, and based on 100 parts by mass of the vinyl chloride based resin (A), it is preferably 1 part by mass˜150 parts by mass, more preferably 10 parts by mass˜100 parts by mass. By setting it to more than 1 part by mass, appropriate rigidity can be imparted to the wire covering material. By setting it to less than 150 parts by mass, a lowering of the flexibility of the wire covering material can be prevented.

<Flame Retardant (E)>

In the vinyl chloride based resin composition that is molded into a wire covering material, it may further contain a flame retardant (E).

Flame retardant (E) is not particularly limited, and preferably is selected from at least one of metal hydroxide, bromine based compounds, triazing ring containing compounds, zinc compounds, phosphorus based compounds, halogen based flame retardants, silicone based flame retardants, intumescent based flame retardant and antimony oxide. The flame retardant may be used alone or used in a combination of two or more of the above compounds.

Regarding the addition amount of the flame retardant (E), it is not particularly limited, and based on 100 parts by mass of the vinyl chloride based resin (A), it is preferably 1 part by mass˜150 parts by mass, more preferably 10 parts by mass˜100 parts by mass. By setting it to above 1 part by mass, the flame retardancy of the wire covering material may be improved. By setting it to less than 150 parts by mass, the lowering in the flexibility of the wire covering material may be prevented.

In the vinyl chloride based resin composition that is molded into the wire covering material of the present invention, as long as the effects of the invention are not compromised, various additives such as conventional stabilizers, lubricants, impact resistance modifiers may be added based on requirements.

Stabilizers may for example include: lead stabilizers such as tribasic lead sulfate, dibasic lead phosphite, dibasic lead sulphate, or lead silicate; metal soap stabilizers derived from a metal such as potassium, magnesium, barium, zinc, cadmium, or lead and fatty acid such as 2-ethylhexanoate, lauric acid, myristic acid, palmitic acid, stearic acid, isostearic acid, hydroxy stearic acid, oleic acid, ricinoleic acid, linolenic acid, or behenic acid; organic tin stabilizers having an alkyl group, an ester group, a fatty acid group, a maleic acid group or a sulfide containing group; composite metal soap stabilizers such as Ba—Zn, Ca—Zn, Ba—Ca—Sn, Ca—Mg—Sn, Ca—Zn—Sn, Pb—Sn, or Pb—Ba—Ca; metal salt stabilizers generally derived from two or more of a metal group such as barium or zinc and branched fatty acid such as 2-ethylhexanoate, isodecyl acid, or trialkyl acetic acid, unsaturated fatty acid such as oleic acid, ricinoleic acid, or linolenic acid; alicyclic acid such as naphthenic acid, organic acid such as aromatic acid such as carbolic acid, benzoic acid, salicylic acid, derivatives thereof; a metal stabilizer such as a metal salt liquid stabilizer formed by dissolving the stabilizers in an organic solvent such as petroleum hydrocarbon, alcohol, or glycerol derivative, and then adding a stabilizing aid such as phosphite, an epoxy compound, an anti-coloring agent, a transparency-improvement agent, a light stabilizer, an antioxidant, an anti-seep agent, or a lubricant. Moreover, a non-metal stabilizer such as an epoxy compound such as an epoxy resin or an epoxidized fatty acid alkyl ester, or an organic phosphite may also be included. The stabilizers can be used alone or in a combination of two or more.

The addition amount of the stabilizer is not particularly limited, and based on 100 parts by mass of the vinyl chloride resin (A), it is preferably 1 parts by mass˜15 parts by mass, more preferably 1 parts by mass˜8 parts by mass. By using 1 part by mass or more, thermal decomposition during processing can be suppressed. By using 15 parts by mass or less, reduction in the mechanical properties of the wire covering material can be prevented.

Moreover, the lubricant for example may include: a pure hydrocarbon lubricant such as liquid paraffin, natural paraffin, micro wax, synthetic paraffin, or low molecular weight-polyethylene, a fatty acid lubricant such as a halogenated hydrocarbon lubricant, higher fatty acid, or oxy fatty acid, a fatty acid amide lubricant such as fatty acid amide or di-fatty acid amide, polyol ester of fatty acid such as lower alcohol ester of fatty acid or glyceride, an ester lubricant such as polyglycol ester of fatty acid or fatty alcohol ester (ester wax) of fatty acid. Moreover, metal soap, fatty alcohol, polyol, polyglycol, polyglycerol, partial ester of fatty acid and polyol, partial ester of fatty acid and polyglycol or polyglycerol can also be used. The lubricants can be used alone or in a combination of two or more.

The addition amount of the lubricant is not particularly limited, and based on 100 parts by mass of the vinyl chloride based resin (A), it is preferably 0.1 parts by mass˜15 parts by mass, more preferably 0.1 parts by mass˜5 parts by mass. By using 0.1 parts by mass or more, adhesion of the resin composition to the molding machine can be reduced. By using 15 parts by mass or less, the reduction in processability can be prevented.

Furthermore, when the impact resistance modifier is used, examples thereof may include, for instance: acrylic core-shell rubber such as chlorinated polyethylene, polybutadiene, polyisoprene, polychloroprene, fluororubber, styrene-butadiene copolymer rubber, acrylonitrile-styrene-butadiene copolymer rubber, methyl methacrylate-styrene-butadiene copolymer rubber, or acrylate-methacrylate copolymer, silicone-core-shell rubber such as silicone-acrylate-methacrylate copolymer or silicone-acrylate-acrylonitrile-styrene copolymer, styrene-butadiene-styrene block copolymer rubber, styrene-isoprene-styrene block copolymer rubber, styrene-ethylene-butylene-styrene block copolymer rubber, ethylene-propylene copolymer rubber, or ethylene-propylene-diene copolymer rubber (EPDM). The diene of EPDM can include: 1,4-hexadiene, dicyclopentadiene, methylene norbornene, ethylidene norbornene, or propenyl norbornene. The impact resistance modifiers can be used alone or in a combination of two or more.

The addition amount of the impact resistance modifier is not particularly limited, and based on 100 parts by mass of the vinyl chloride based resin (A), it is preferably 1 part by mass˜20 parts by mass, more preferably 1 part by mass˜15 parts by mass. By using 1 part by mass or more, the impact strength of the wire covering material can be increased, and by using 20 parts by mass or less, reduction in molding appearance can be prevented.

Moreover, as long as the effects of the invention are not compromised, foaming agent, mold-release agent, flowability improver, colorant, anti-static agent, surfactant, anti-fogging agent, and antibacterial agent can also be arbitrarily used based on requirements.

The method of obtaining the vinyl chloride based resin composition that is molded into the wire covering material of the invention is not particularly limited, and a common method may be used. For instance, the following methods can be used: a Henschel mixer, a Banbury mixer, a V-type mixer, and a belt blender, wherein specific amounts of the vinyl chloride based resin (A), the processing aid (B), and the plasticizer (C) are mixed.

The wire covering material of the invention can obtain a good appearance even under high linear speed production conditions. The high linear speed production conditions refer to, for instance, extruding and coating a thin wire having a diameter of about 1 to 5 mm φ at 1000 m/min or more, and extruding and coating a thick electric wire having a diameter of about 50 mm φ at 15 m/min to 30 m/min. In this case, for example, the shear rate can reaches 5000/s˜15000/s.

The wire covering material of the present invention can be directly covered onto a conductor, or may be used as a sheath material of a general insulated wire and covered thereon. In the case of manufacturing a covered wire, the conditions are not particularly limited, and general methods may be used for its production.

For instance, the following methods may be used for coating: kneading the vinyl chloride based resin composition using a roller, a Banbury mixer, or an extruder, then a known extruder for a wire provided with a cross-head die is used for the wire covering, extrusion and molding process as performed for the pellet compound and the conductor.

### EXAMPLES

In the following, the invention is specifically described by way of examples. However, the invention is not limited to these examples.

Moreover, “parts” in each example and comparative example represents “parts by mass”. Evaluation is performed via the following methods.

(1) Evaluation of Appearance

The vinyl chloride based resin composition of the invention was provided to a 25 mm single-screw extruder (made by Thermo Plastics, 130° C.-145° C.-160° C.-160° C. (C1-C2-C3-D), screw speed: 80 rpm), it was then extruded and pelletized.

At this time, a small single-screw extruder with low kneading was used under high speed rotation conditions. Hereby, the high speed extrusion and low kneading condition is reproduced.

The resulting pellet were filled in a capillary rheometer (made by Malvern, barrel: φ15 mm, 160′C, mold: φ 1.0 mm*16 mm), and extrusion was performed at a shear rate of 10000/s. The resulting strand surface was observed and the number of irregularities on the surface at every 5 cm of the molded product was counted using the naked eye.

A maximum shear rate of a covered wire generally at 7000/s is considered as standard, by increasing the production speed, the shear rate is also increased, and the product was evaluated at a shear rate of 10000/s.

### Examples, Comparative Examples

Besides adding various processing aids in 5 parts, specific amounts of various plasticizers, 100 parts of a vinyl chloride based resin (TK-1300, made by Shin-Etsu Chemicals, average degree of polymerization: 1300, average chlorine content: 57 mass %), 4 parts of a Ca—Zn composite stabilizer as the stabilizer (RUP-103, made by ADEKA), 40 parts of calcium carbonate as the filler (Whiton SSB Blue, made by Shiraishi Calcium Kaisha, Ltd.), 30 parts of aluminum hydroxide used as the flame retardant (Hidilite H-31, made by Showa Denko K.K.), and 0.5 parts of montanate used as the lubricant (OP-Wax, made by Hoechst) were provided to a Henschel mixer and uniformly mixed to obtain a vinyl chloride based resin composition.

The following are used for the processing aid.

### Production Example 1

### Production of Processing Aid (B-1)

In a reaction vessel provided with a mixer and a reflux condenser, 180 parts of ion-exchanged water was added, and then 0.1 parts of anhydrous sodium carbonate, 15 parts of n-butyl methacrylate (n-BMA), 81 parts of methyl methacrylate (MMA), 4 parts of n-butyl acrylate (n-BA) and 0.15 parts of n-octyl mercaptan (n-OM) were added thereto. Then, substitution was performed inside the vessel using nitrogen.

In particular, 1.1 parts of sodium lauryl sulfate was added, and the reaction vessel was heated to 45° C. while stirring. After 0.15 parts of potassium persulfate was added to start the polymerization reaction, heating and stirring were performed for 2 hours to end the polymerization. After cooling the resulting emulsion, spray drying was performed under the conditions of an inlet temperature of 150° C. and an outlet temperature of 65° C. to obtain the processing aid (B-1).

### Production Example 2 to Production Example 6

### Production of Processing Aid (B-2 to B-6)

Besides changing the compositions of the monomer components and the addition amount of the n-octyl mercaptan as shown in Table 1, each processing aid B-2˜B-6 was produced the same way as shown in production example 1.

The following processing aids are used for B-7˜B-10.

(B-7) acrylic processing aid P551 (made by Mitsubishi Rayon, methyl methacrylate high-molecular weight polymer/without (b-1) component)

(B-8) acrylic processing aid P530 (made by Mitsubishi Rayon, methyl methacrylate high-molecular weight polymer/without (b-1) component)

(B-9) acrylic processing aid PA40 (made by Kaneka, methyl methacrylate-butyl acrylate copolymer)

(B-10) acrylic processing aid K125 (made by Dow, methyl methacrylate-ethyl acrylate-n-butyl methacrylate-ethyl methacrylate copolymer/n-butyl methacrylate content less than 10 mass %)

TABLE 1

| | | | Production | Production | Production | Production | Production | Production |
|---|---|---|---|---|---|---|---|---|
| | | | example 1 | example 2 | example 3 | example 4 | example 5 | example 6 |
| Monomer | (b-1) | n-BMA | 15 | 29 | 50 | 98 | 29 | — |
| component | (b-2) | MMA | 81 | 68 | 48 | — | 68 | 96 |
| (parts by mass) | (b-3) | n-BA | 4 | 3 | 2 | 2 | 3 | 4 |

| | | | | | | | |
|---|---|---|---|---|---|---|---|
| Chain-transfer agent | n-OM | 0.15 | 0.15 | 0.15 | 0 | 0 | 0.15 |

| | | | | | | |
|---|---|---|---|---|---|---|
| Rate of polymerization [%] | 99 | 99 | 99 | 99 | 99 | 99 |
| Reduced viscosity ηsp/c | 7 | 7 | 7 | 12 | 10 | 7 |
| Processing aid (B) | (B-1) | (B-2) | (B-3) | (B-4) | (B-5) | (B-6) |

The abbreviation in the table are as below.

n-BMA: n-butyl methacrylate

MMA: methyl methacrylate

n-BA: n-butyl acrylate

n-OM: n-octyl mercaptan

Here, the rate of polymerization is calculated by quantitating the residual monomer content of the polymerized emulsion solution via gas chromatography.

The following can be used for the plasticizer.

Diisononyl phthalate (DINP, made by J-Plus)

Tris(2-ethylhexyl)trimellitate (TOTM, Monocizer W-705, made by DIC)

Tricresyl phosphate (TCP, made by Daihachi Chemical Industry, Co.)

Acetyl tributyl citrate (ATBC, Monocizer ATBC, made by DIC)

Epoxidized soybean oil (ESBO, EMBILIZER NF-3200, made by Tokyo Seika Co.)

Polyester based plasticizer (W230S, Polycizer W-230-S, made by DIC)

TABLE 2

| | | Example 1 | Example 2 | Example 3 | Example 4 | Example 5 |
|---|---|---|---|---|---|---|
| Vinyl chloride resin (A) [parts] | | 100 | 100 | 100 | 100 | 100 |
| Plasticizer | DINP | 50 | 50 | 50 | 50 | 50 |
| (C) [parts] | TOTM | — | — | — | — | — |
| | TCP | — | — | — | — | — |
| | ATBC | — | — | — | — | — |
| | ESBO | — | — | — | — | — |
| | W230S | — | — | — | — | — |
| Processing | [parts] | 5 | 5 | 5 | 5 | 5 |
| aid (B) | Type | (B-1) | (B-2) | (B-3) | (B-4) | (B-5) |

| | | | | | |
|---|---|---|---|---|---|
| (B) Reduced viscosity ηsp/c | 1 | 7 | 7 | 12 | 10 |
| (b-1) content [mass %] | 15 | 29 | 50 | 98 | 29 |
| Number of surface irregularities | 11 | 12 | 8 | 17 | 17 |
| [number/5 cm] | | | | | |

| | | Comparative | Comparative | Comparative | Comparative | Comparative | Comparative |
|---|---|---|---|---|---|---|---|
| | | example 1 | example 2 | example 3 | example 4 | example 5 | example 6 |
| Vinyl chloride resin (A) [parts] | | 100 | 100 | 100 | 100 | 100 | 100 |
| Plasticizer | DINP | 50 | 50 | 50 | 50 | 50 | 50 |
| (C) [parts] | TOTM | — | — | — | — | — | — |
| | TCP | — | — | — | — | — | — |
| | ATBC | — | — | — | — | — | — |
| | ESBO | — | — | — | — | — | — |
| | W230S | — | — | — | — | — | — |
| Processing | [parts] | — | 5 | 5 | 5 | 5 | 5 |
| aid (B) | Type | — | (B-6) | (B-7) | (B-8) | (B-9) | (B-10) |

| | | | | | | |
|---|---|---|---|---|---|---|
| (B) Reduced viscosity ηsp/c | — | — | 4 | 10 | 9 | 5 |
| (b-1) content [mass %] | — | — | 0 | 0 | 0 | 8 |
| Number of surface irregularities | 58 | 41 | 43 | 35 | 53 | 54 |
| [number/5 cm] | | | | | | |

### Examples 1˜Examples 5

It can be known from the results of table 2 that, in comparison to wire covering materials of example 1 to example 5 containing the (b-1) component within the range of the invention, the case without the processing aid (comparative example 1) and the case in which the processing aid is added in an amount outside the range of the invention (comparative example 2 to comparative example 6), the molding appearance is significantly improved. The reason for such an effect is that a specific processing aid of the invention is used in a defined amount and wherein the kneading and dispersibility is good in the present invention.

### Comparative Examples 2˜Comparative Example 5

In comparative example 2 to comparative example 5, the processing aid (B-6) to processing aid (B-9) without the component (b-1) are used, and an appearance improvement effect is not observed. The reason being determined as due to: in the cases of using the abovementioned processing aids, kneading is the insufficient.

### Comparative Example 6

In the comparative example where the processing aid (B-10) contains the component (b-1) in an amount outside the range of the present invention, an appearance improvement effect is not observed. It is confirmed that the appearance improvement effect is even worse than comparative example 2 to comparative example 5 that do not contain the component (b-1). The reason for such an effect can be determined as due to: the gelling promoting effect cannot be sufficiently provided by the processing aid (B-10), and that its compatibility with the vinyl chloride based resin is lower than the processing aids that do not contain the component (b-1).

Based on the results above, it can be known that by containing an appropriate portion of alkyl methacrylate for which the alkyl ester part includes a straight chain or branched alkyl group having 3 to 5 carbons, there will be a significant difference to the appearance improvement effect.

TABLE 3

| | | | Compar- | Compar- | | Compar- | Compar- | | Compar- | Compar- |
|---|---|---|---|---|---|---|---|---|---|---|
| | | | ative | ative | | ative | ative | | ative | ative |
| | | Exam- | exam- | exam- | Exam- | exam- | exam- | Exam- | exam- | exam- |
| | | ple 6 | ple 7 | ple 8 | ple 7 | ple 9 | ple 10 | ple 8 | ple 11 | ple 12 |
| Vinyl chloride resin (A) [parts] | | 100 | 100 | 100 | 100 | 100 | 100 | 100 | 100 | 100 |
| Plasticizer | DINP | 20 | 20 | 20 | — | — | — | — | — | — |
| (C) [parts] | TOTM | — | — | — | 50 | 50 | 50 | — | — | — |
| | TCP | — | — | — | — | — | — | 50 | 50 | 50 |
| | ATBC | — | — | — | — | — | — | — | — | — |
| | ESBO | — | — | — | — | — | — | — | — | — |
| | W230S | — | — | — | — | — | — | — | — | — |
| Processing | [parts] | 5 | — | 5 | 5 | — | 5 | 5 | — | 5 |
| aid (B) | Type | (B-2) | — | (B-7) | (B-2) | — | (B-7) | (B-2) | — | (B-7) |
| (B) Reduced viscosity ηsp/c | | 7 | — | 4 | 7 | — | 4 | 7 | — | 4 |
| (b-1) content [mass %] | | 29 | — | 0 | 29 | — | 0 | 29 | — | 0 |
| Number of surface irregularities | | 40 | 61 | 50 | 12 | 51 | 41 | 11 | 31 | 30 |
| [number/5 cm] | | | | | | | | | | |
| | | | Compar- | Compar- | | Compar- | Compar- | | Compar- | Compar- |
| | | | ative | ative | | ative | ative | | ative | ative |
| | | Exam- | exam- | exam- | Exam- | exam- | exam- | Exam- | exam- | exam- |
| | | ple 9 | ple 13 | ple 14 | ple 10 | ple 15 | ple 16 | ple 11 | ple 17 | ple 18 |
| Vinyl chloride resin (A) [parts] | | 100 | 100 | 100 | 100 | 100 | 100 | 100 | 100 | 100 |
| Plasticizer | DINP | — | — | — | — | — | — | — | — | — |
| (C) [parts] | TOTM | — | — | — | — | — | — | — | — | — |
| | TCP | — | — | — | — | — | — | — | — | — |
| | ATBC | 50 | 50 | 50 | — | — | — | — | — | — |
| | ESBO | — | — | — | 50 | 50 | 50 | — | — | — |
| | W230S | — | — | — | — | — | — | 50 | 50 | 50 |
| Processing | [parts] | 5 | — | 5 | 5 | — | 5 | 5 | — | 5 |
| aid (B) | Type | (B-2) | — | (B-7) | (B-2) | — | (B-7) | (B-2) | — | (B-7) |

| | | | | | | | | | |
|---|---|---|---|---|---|---|---|---|---|
| (B) Reduced viscosity ηsp/c | 7 | — | 4 | 7 | — | 4 | 7 | — | 4 |
| (b-1) content [mass %] | 29 | — | 0 | 29 | — | 0 | 29 | — | 0 |
| Number of surface irregularities | 0 | 12 | 10 | 10 | 35 | 25 | 7 | 34 | 26 |
| [number/5 cm] | | | | | | | | | |

From the results shown in table 3, it can be known that in example 6 to example 11, the component (b-1) is in an amount of the claimed range, therefore, no matter what is the amount and type of plasticizer used, as compared to examples with the same composition but without the processing aid (comparative example 7, comparative example 9, comparative example 11, comparative example 13, comparative example 15, comparative example 17), and compared to examples with the same composition but having the processing aid in an amount outside of the range of the present invention (comparative example 8, comparative example 10, comparative example 12, comparative example 14, comparative example 16, comparative example 18), in any of the situations where the plasticizer is used, the molding appearance is significantly improved. The reason for such an effect can be determined as due to: by using the processing aid of the present invention, the kneading and dispersion of the processing aid in the vinyl chloride based resin is good.

### DESCRIPTION OF SYMBOLS

None

What is claimed is:

1. A wire covering material, wherein the wire covering material is formed by molding a vinyl chloride based resin composition which includes 0.1 to 20 parts by mass of (B) and 10 to 150 parts by mass of (C) based on 100 parts by mass of (A):
(A) a vinyl chloride based resin;
(B) a powdery processing aid including an alkyl methacrylate based copolymer which is obtained by polymerizing 10 mass % to 100 mass % of an alkyl methacrylate for which an alkyl group of an alkyl ester part includes a straight chain or branched alkyl group having 3 to 5 carbons, 0 mass % to 90 mass % of a methyl methacrylate, and 0 mass % to 20 mass % of other copolymerizable monomer;
(C) a plasticizer.

2. The wire covering material according to claim 1, wherein the straight chain or branched alkyl group having 3 to 5 carbons is a straight chain or branched alkyl group having 4 carbons.

3. The wire covering material according to claim 1, wherein the straight chain or branched alkyl group having 3 to 5 carbons is a straight chain alkyl group.

4. The wire covering material according to claim 1, wherein the alkyl methacrylate for which the alkyl ester part includes the straight chain or branched alkyl group having 3 to 5 carbons used in the processing aid (B) is n-butyl methacrylate.

5. The wire covering material according to claim 1, wherein the vinyl chloride based resin composition further comprises 1 part by mass to 150 parts by mass of a filler (D).

6. The wire covering material according to claim 5, wherein the filler (D) is at least one selected from the group consisting of calcium carbonate, talc, titanium oxide, clay, mica, silica limestone, zeolite, silica, carbon black, graphite, glass beads, glass fibers, carbon fibers, metal fibers and organic fibers.

7. The wire covering material according to claim 1, wherein the vinyl chloride based resin composition further comprises 1 part by mass to 150 parts by mass of a flame retardant (E).

8. The wire covering material according to claim 7, wherein the flame retardant (E) is at least one selected from the group consisting of metal hydroxides, bromine based compounds, triazine ring containing compounds, zinc compounds, phosphorus based compounds, halogen based flame retardants, silicone based flame retardants, intumescent based flame retardant and antimony oxide.

9. The wire covering material according to claim 1, wherein the plasticizer (C) is at least one selected from the group consisting of o-phthalic acid based compounds, trimellitic acid based compounds, phosphoric acid based compounds, adipic acid based compounds, citric acid based compounds, ether based compounds, polyester based compounds and soybean oil based compounds.

10. The wire covering material according to claim 1, wherein the vinyl chloride based resin (A) is at least one selected from a vinyl chloride polymer having an average chlorine content of 56 mass % to 75 mass % and a vinyl chloride based copolymer formed by copolymerizing the vinyl chloride polymer with an elastomeric body and/or elastomer.

11. A wire, covered by the wire covering material according to claim 1.
